(19) United States
(12) Patent Application Publication
(10) Pub. No.: US 2019/0275726 A1
(43) Pub. Date: Sep. 12, 2019

(54) APPARATUS AND METHOD FOR EXPANDING AND SIMULTANEOUSLY FILLING CONTAINERS

(71) Applicant: KRONES AG, Neutraubling (DE)

(72) Inventors: CHRISTIAN BETZ, GEIGANT (DE); THOMAS KITZINGER, Regensburg (DE); DOMINIK MEIER, Parsberg (DE); ANDREAS VORNEHM, Offenberg (DE); DIETER FINGER, NEUTRAUBLING (DE); CORA HANESCH, Regensburg (DE); ANDREAS PENSE, Regensburg (DE)

(21) Appl. No.: 16/210,384

(22) Filed: Dec. 5, 2018

(30) Foreign Application Priority Data
Mar. 7, 2018 (DE) 10 2018 105 229.4

(51) Int. Cl. B29C 49/46; B65B 3/02; B29C 49/78; B29C 49/06; B67C 3/26

(52) U.S. Cl. CPC B29C 49/46; B65B 3/022; B29C 49/783; B29L 2031/7158; B67C 3/26; B29C 2049/4664; B29C 49/06

(57) ABSTRACT

Provided is an apparatus for expanding plastics material parisons into plastics material containers by a liquid medium having at least one transforming station, which fills and expands the plastics material parisons with the liquid medium with at least one delivery device, which delivers the liquid medium to a filling device of this transforming station, wherein this filling device is suitable and intended to fill the liquid medium into the plastics material parisons, and wherein the apparatus has a pressure generating device which delivers the liquid medium under pressure to the filling device. According to embodiments of the invention the pressure generating device has at least two pressure generating units which are suitable and intended to provide the liquid medium under pressure to the filling device.

### CROSS-REFERENCE TO RELATED APPLICATION

This application claims priority to German Application No. 10 2018 105 229.4, having a filing date of Mar. 7, 2018, the entire contents of which are hereby incorporated by reference.

### FIELD OF TECHNOLOGY

The following relates to an apparatus and a method for producing liquid containers and in particular beverage containers. Such methods have been known for a long time from the known art. In conventional methods, heated plastics material parisons are first expanded to plastics material bottles, which takes place for example in blow moulding machines. These containers thus expanded are then filled with a filling material, such as for instance a beverage.

More recently, apparatus and methods have become known in which plastics material parisons are filled directly with the filling material to be filled and in this case are also expanded. For this purpose, it is known that the pressure by which the liquid filling material is filled into the plastics material parison to be expanded is generated by means of a pressure generating device or a pressure application device, such as for instance a pump or also a piston. For this purpose, in some instances very high levels of performance for the drives of such pistons are necessary. In some instances, it is also desirable not to fill the containers with a pure product, but with a product mixture.

Currently, for shaping containers with a liquid medium which subsequently remains in the container, a mould unit is used which is basically made up of two assemblies. These assemblies are defined on the one hand by a filling cylinder (also referred to below as a pressure generating unit) and on the other hand by a filling head (referred to below as a filling device). In the known art the filling cylinder is single-acting and is supplied with a liquid medium, in particular the filling material, by means of a supply line from a central liquid reservoir. In the known art the feed conduit between the central liquid reservoir and the filling cylinder can be shut off by a shut-off device.

If the filling cylinder is filled, the shut-off device is closed, and the flow is shut off. In a moulding process the liquid medium is pressed out of the filling cylinder into the filling head.

In this case the connection between the filling cylinder and the filling head is at least designed with a channel, and in the known art these channels cannot be shut off. A continuous flow from the filling cylinder to the filling head is possible at any time.

The filling head sits on the plastics material parison before the moulding process and also seals the interface to the plastics material parison. In the known art the filling head is tightly closed by a sealing stopper.

After the setting of an initial pressure in the filling head, in particular by the movement of the filling piston, the sealing stopper is opened. The shaping process begins with this step, wherein the plastics material parison is transformed into a container by the action of the liquid medium and possibly also a stretching rod.

In order to be able to reproduce the contour of this shape optimally on the container, a period of time with a constant internal container pressure (pressure holding time) is necessary, which in the known art is achieved by stopping the piston.

### SUMMARY

An aspect of embodiments of the present invention is to make such apparatus and methods more efficient and more versatile in use. The high peak outputs for pressure generating devices should also be reduced as far as possible.

An apparatus according to embodiments of the invention for expanding plastics material parisons into plastics material containers by means of a liquid medium has at least one transforming station which fills and expands the plastics material parisons with the liquid medium. Furthermore, the apparatus has at least one delivery device which delivers the liquid medium to a filling device of this transforming station, wherein this filling device is suitable and intended to introduce the liquid medium into the plastics material parisons, and wherein the apparatus has a pressure generating device which delivers the liquid medium under pressure to the filling device.

According to embodiments of the invention the pressure generating device has at least two pressure generating units which are suitable and intended to provide and/or to deliver the liquid medium under pressure to the transforming station.

It is therefore proposed that, instead of the one pressure generating unit usually used in the known art, two pressure generating units or also several pressure generating units are used. This offers different advantages. Thus, for example the variability is increased, because different products can also be delivered by the two pressure generating units. In this way the performance requirements can be lowered on only one pressure generating unit, and the unit can have smaller dimensions or can also be operated at lower power.

Within the context of the present application the transforming station is understood to be the entire facility, which in particular also comprises at least one pressure generating device and at least one filling device. The filling device is understood to be the component of the apparatus which introduces the liquid into the respective container.

In a further advantageous embodiment, the machine has a plurality of such transforming stations. In this case it is possible and preferable that in each case two or possibly also several pressure generating units are assigned to each of these transforming stations. The apparatus has a carrier on which the transforming stations are arranged. In particular in this case this may be a rotatable carrier and in particular a carrier which is rotatable about a predetermined axis of rotation, on the outer periphery of which the transforming stations are arranged. However, it would also be conceivable that the transforming stations are transported at least at sections along a rectilinear transport path. Thus, the transforming stations could be arranged for instance on a circulating chain. It would also be conceivable that the transforming stations are transported in a straight line or that the containers are introduced into stationary transforming stations or are transported to them.

In a further preferred embodiment, the transforming station has a transforming mould, inside which the plastics material parisons can be arranged in order to expand them with the liquid product. In this case these transforming moulds can be configured in such a way that the plastics material parisons are expanded against inner walls of these transforming stations.

In a further advantageous embodiment, the machine has a pressure measuring device which at least at times measures the pressure of the medium to be filled. In this case this pressure measuring device can be arranged for example on a filling head (that is to say in particular in a region of the filling device).

In a further advantageous embodiment, the apparatus has a positioning device in order to position the filling head on the respective plastic parison.

In a further preferred embodiment, the transforming station has a stretching rod which can be introduced into the interior of the plastics material parisons in order to expand these containers in their longitudinal direction. In this case it is also possible that this stretching rod is designed as a hollow body and has in the interior a channel for conveying a flowable, in particular liquid medium.

In the known art in some instances the problem arises that the liquid to be filled cools a plastics material parison more quickly than air and in this way very high filling speeds are necessary in order to expand the plastics material parison. In fact, the plastics material parison should be deformed in a state in which it is still as hot as possible, in particular in order to avoid stress whitening. Thus, for example in a 1.5 l bottle in 0.1 seconds an average volume flow of 15 l/sec is necessary, which in turn means a relatively high load with regard to dimensioning of a drive of the pressure generating device. The nominal widths of the components are also kept very high by the very high-volume flow.

Thus, in the case of larger containers, in order, in spite of everything to find a drive in which there are still reserves of torque, it would be necessary to change to another concept. If even larger bottle types are to be produced, higher volume flows must be implemented. Moreover, the counter-pressure of the head and of the components through which the flow passes increases because of the higher flow speed. As a result, the drive must also operate higher loads. These two relationships are contradictory and can therefore lead to large problems in the optimisation of the drive, since components which can operate higher loads generally have a higher inertia and thus simply cannot achieve any higher dynamics.

The embodiment overcomes this problem by the provision of two pressure generating devices which on the one hand can jointly produce the respective pressure level and/or the necessary total volume flow, wherein on the other hand, however, particularly heavy components can be dispensed with.

Therefore, as mentioned above, it is proposed that the pressure generation is not carried out by one single drive or by one pressure generating unit, but by several thereof, and in particular by several thereof simultaneously. As mentioned in greater detail below, this may be expedient both in the case of pumps and in the case of piston/cylinder drives. The requirements of the respective drives with regard to dynamic load and diameter of the piston are clearly lower if these requirements are met in particular by a skilful parallel connection or possibly also in series connection of the drive components.

In a further advantageous embodiment, the two pressure generating units are connected in parallel in such a way that they can jointly deliver the liquid medium to the transforming station and can also deliver it simultaneously. In this case it is possible that the two pressure generating units are operated in parallel, that is to say they are controlled in the same way. It would also be possible that the pressure generating units are controlled differently, in order for instance to be able to meet different pressure and volume flow requirements during the filling and expanding process. In addition, however, a series connection of the pressure generating units would also be possible.

In a further preferred embodiment, the at least two pressure generating units or both pressure generating units are in each case connected by means of liquid conduits to the filling device. In this case these are partially separate and completely separate liquid conduits which connect the two pressure generating units in each case to the filling device, that is to say in particular the filling head. In this way the liquid can be delivered to the filling device by means of these two separate feed conduits.

The pressure generating units also have, at least partially and substantially completely, separate feed conduits, which again deliver the liquid (to be filled) (in particular from a reservoir) to the pressure generating units.

In a further advantageous embodiment, the filling device has a collecting chamber to receive the liquid medium. The above-mentioned liquid conduits can open into this collecting chamber. Particularly, the two supply conduits open into the collecting chamber at different positions, for example at different positions in a peripheral direction of the filling device. This peripheral direction can be defined for example with respect to the longitudinal direction of the plastics material parisons to be expanded.

In a further advantageous embodiment, the filling device has a collecting chamber to receive the liquid medium. This collecting chamber is at least at times fluidically connected to each of the pressure generating units. In this case, however, it would be possible that valves which can control a product stream from the respective pressure generating unit to the collecting chamber are provided between the collecting chamber and the pressure generating device.

In a further advantageous embodiment, the pressure generating units in each case have driving devices which are particularly controllable independently of one another. These driving devices can have motor-powered drives and in particular electric motor-powered drives and in particular linear motor-powered drives. Thus, for example a linear motor can be provided which carries out a piston movement. In this case this linear motor can be connected to the piston device described in greater detail below.

The driving device can have a transmission unit, for example a planetary gear transmission. Particularly, the driving device also has a spindle drive.

In a further preferred embodiment, the driving device also has a position detection device which detects a position of a pressure cylinder. In this way the delivery of the liquid medium into the plastics material parisons can be controlled and/or regulated in a targeted manner.

In a further advantageous embodiment, the pressure generating units in each case have a liquid chamber and a piston device which is movable relative to this fluid chamber. The liquid is ultimately pressed into the containers here by a movement of this piston device. In a further preferred embodiment at least one pressure generating unit and both pressure generating units are pumping devices and in particular pumping devices which are selected from a group of pumping devices including hydraulic pumps, sinus pumps, axial piston pumps, bellows pumps, diaphragm pumps, scroll pumps, rotary piston pumps, eccentric screw pumps, screw conveyors, impeller pumps, chain pumps, annular piston pumps, hose pumps, screw spindle pumps, shaker pumps, toothed belt pumps and the like.

In a preferred embodiment the compressed volume flows generated by the pressure generating units can be collected in the filling head which in particular rests sealingly against the parison and particularly ensures a constant flow front. The filling head has a sealing stopper which, depending upon the position, can free the path to the plastics material parison. In addition, it would also be conceivable that the pressure generating units have a piston device which at least at times can be pressed down once again in order to generate pressure peaks in in this way.

In addition, it would also be conceivable that different pressure levels are implemented by the two pressure generating units, wherein particularly annular channels are provided which serve for holding or maintaining these different pressure levels. In this way it would be possible to achieve different pressure levels. Thus, for example it would be conceivable that a first annular channel has very large cross-sections, in order thus to provide a low-pressure level and to form the container as quickly as possible.

A second pressure stage can have a very high-pressure level in order to ensure a configuration of the container. For this purpose, for instance an annular channel with a small cross-section could be provided. In this way the two pressure stages could be collected in the filling head (i.e. the filling device).

In a further embodiment it would also be possible to provide several pistons and/or cylinders, in order in this way to keep different products, for example to store them in the pressure cylinders and so to deliver either a mixture of them to the filling device or to deliver them individually.

Furthermore, it is also possible to provide higher volume flows in the event of a constant torque reserve of the drives. With larger dimensions of a drive it is possible that the dynamics can no longer be implemented to the necessary extent and the drive does not cope with the corresponding loads.

In addition, due to embodiments of the invention it would also be more easily possible to operate a very wide spread of volumes of the customer objects. If for example a customer wishes to produce a 0.5 l bottle, for example only one piston could be moved and in the case of a 6.0 l bottle, for example, two or three pistons provide the volume flow. In this way it is possible to adjust a corresponding system respectively to different customer requirements, wherein it is also possible to cover any necessary maxima by a skilled combination of the pressure generating units.

In a further advantageous embodiment, the filling device has a closure element which in at least one position shuts off an inflow of the liquid into the container and in at least one position allows this inflow. In this case the closure element may be for example the above-mentioned sealing stopper which, depending upon its position, can prevent or allow a liquid flow into the plastics material parison.

Furthermore, embodiments of the present invention is directed to a method for expanding plastics material parisons into plastics material containers by means of a liquid medium and in particular by means of a filling product, wherein at least one transforming station fills and expands the plastics material parisons with the liquid medium, and wherein with at least one delivery device the liquid medium is delivered to a filling device of the transforming station, wherein the filling device fills the liquid medium into the plastics material parisons, and wherein a pressure generating device delivers the liquid medium under pressure to the transforming station.

According to embodiments of the invention the pressure generating device has at least two pressure generating units which provide the liquid medium under pressure to the transforming station.

It is therefore also proposed by the method that the pressure for expanding the plastics material parisons is provided by means of at least two pressure generating units. These pressure generating units deliver the pressure at least partially simultaneously.

An apparatus according to embodiments of the invention for expanding plastics material parisons into plastics material containers by means of a liquid medium has at least one transforming station which fills and expands the plastics material parisons with the liquid medium. Furthermore, the apparatus has at least one delivery device which delivers the liquid medium to a filling device of this transforming station, wherein this filling device is suitable and intended to introduce the liquid medium into the plastics material parisons, and wherein the apparatus has at least one pressure generating device which delivers the liquid medium under pressure to the filling device.

According to embodiments of the invention the pressure generating device has a pretensioning device which pretensions at least one element of the pressure generating device.

Thus, in this embodiment it is also proposed to reduce the peak power, but in this case in particular it is proposed that at least one element of the pressure generating device, for example a piston device, is pretensioned.

Thus, in order to reduce the load on the drive for the pressure generation it is proposed to operate with a pretensioning of this drive. In particular this is a translational pretensioning.

In a preferred embodiment the pressure generating device has a receiving chamber for the liquid medium as well as a piston device which is movable relative to this receiving chamber in order to force the liquid medium to the filling device by a piston movement of this piston device. Thus, in this embodiment the pressure generating device is designed as a movable piston or has a movable piston.

Particularly, the pretensioning device acts on this piston device at least indirectly and forces it in a predetermined direction. In particular the pretensioning device forces the piston device in a direction which causes a reduction in size of the receiving chamber and in particular causes the liquid medium to flow or to be forced in the direction of the plastics material parison to be expanded and to be filled.

In a further advantageous embodiment, the pretensioning device pretensions the element of the pressure generating device in a translational direction. Therefore, the piston device moves in a translational or linear direction and the pretensioning device also causes pretensioning in precisely this direction.

In a further advantageous embodiment, the pretensioning device has a pretensioning element which is selected from a group of pretensioning elements which includes mechanical springs, permanent magnet springs, pneumatic springs, hydraulic elements, linear motor-powered elements, combinations thereof, and the like.

Thus, for example a mechanical spring could be provided which acts on the piston device, and for example is articulated on a rear side of the piston device. In addition, the pretensioning could also be configured as a hydraulic spring. Thus, for example a hydraulic spring could be ensured by means of a pre-feed pump. In addition, however, a rotational pretensioning could also be provided, for instance in the manner of a torsion spring. In addition, a separate pump could also be provided in order to generate the pretensioning. For this purpose, it would also be conceivable to provide a pressure intensifier with compressed air.

A pretensioning device acts on a rear side of the piston device. However, it would also be possible that this pretensioning device is arranged outside the pressure generating device, in particular in a separate cylinder, which for example has a common axis with the pressure generating device or the filling piston.

It is pointed out that the embodiments described here can also be combined with the above-mentioned embodiments. Embodiments are also conceivable in which both two or several pressure generating devices are used and a pretensioning device is used. Instead of the term “pretensioning device” the terms “loading device” or “urging device” can also be used.

In a further advantageous embodiment, in the interior of a receiving chamber for the liquid medium the pretensioning device generates a pressure which is greater than 2 bar, greater than 4 bar, greater than 6 bar and/or in the interior of the receiving chamber for the liquid medium the pretensioning device generates a pressure which is less than 40 bar, less than 30 bar and particularly less than 20 bar.

The amount of the (mechanical, pneumatic or hydraulic) pretensioning is chosen so that with an entire system of the drive (for example an entire system consisting of motor, spindle and pretensioning) the moulding times of the plastics material parisons are reduced to a minimum.

In a preferred embodiment the apparatus has a pressure reservoir, and in particular a pressure tank, which feeds the respective pretension. This may be the case in particular in the case of a hydraulic or pneumatic pretension. In this case it is possible that the pretension only acts at times, for example offers support only at times (for example only at the end or the start), or also provides (either constant or also different) pretension or support over the entire movement path.

In a further advantageous embodiment, the pretension is changeable. Thus, it would be possible that the pretensioning can be adapted for example to the expansion of different containers. In this case it would be possible that the pretension is constant during the entire movement of the piston device, but it would also be conceivable that the pretension changes during the movement of the piston, or for example only occurs at specific time periods.

In other words, the amount of pretension can have a fixed value (for example can be dynamically adaptable in the case of a mechanical spring (for example by means of the degree of pressure in the case of a pneumatic spring) and/or can be switchable (for example a pneumatic or hydraulic spring)).

In addition, it would also be conceivable that such pretensioning is pneumatic and a corresponding reservoir or a tank is so great that the power assistance over the movement path is almost constant.

In this way the filling of the tank could be performed by movement the piston device up and down, in particular during switching of suitable valves, by compression of the air on the rear side of the filling piston or of the pretensioning piston, and so at least a part of the air required for an expansion tank is produced.

However, the pressure could also be supplied by pressure conduits with different pressures, for example a 10-bar low-pressure conduit or a 40-bar high-pressure conduit.

In a further advantageous embodiment, the pressure generating device has a driving device, in particular an electric motor. In this case this driving device can have a braking device which, if required, can block a movement of the piston device.

In a further advantageous embodiment, the pressure generating device has a piston device which at least at times rests on a piston seat. In this case the pretensioning force can be introduced directly into the piston seat.

In a further advantageous embodiment, the pretensioning device can be switched off. Thus, for example in the event of an emergency stop the pretensioning can be switched off and/or a holding brake of a motor unit, for instance of a servomotor, can be activated.

In an advantageous embodiment the driving device for driving the cylinder device has a nut integrated into a rotor and a spindle (a hollow shaft).

A servomotor with an integrated spindle has many advantages with respect to installation space, weight, dynamics and flexibility. Thus, for example connecting elements between the driving device and the linear screw could be dispensed with.

In addition, it would also be possible that the driving device is designed as a linear motor. Thus, a linear motor could be connected directly to the piston device in order thus to supply the driving force. Also, in this case a pretension could additionally be supplied.

In a further advantageous embodiment, the apparatus has a lever device which is suitable and intended for actuating two pressure generating devices or two cylinders. Thus, the lever device could be for example a toggle lever which supplies the required forces. A pressure profile during shaping of the container necessitates a fast moulding process and so in the case of an almost moulded bottle a shorter path and high holding forces could be used. A toggle lever is particularly advantageous for such an application and is described in greater detail below.

This toggle lever could be driven for example by a servomotor with a linear spindle or also optionally a transmission, or also another drive unit which is movable in the longitudinal direction or rotatable. Here too a pretensioning can be used, but it is pointed out that this concept is also possible without the pretensioning described here.

Due to the geometry and the mode of action of a toggle lever, at the start of the movement path very high speeds and thus also high-volume flows can be achieved, whereas towards the end and at the lower point of the piston drive the volume flows decrease and the force increases theoretically into infinity. Thus, high holding forces could also be implemented.

In addition, a hydraulic driving device could also be used as the driving device. Due to the high pressures which are usual in a hydraulic system, because of the smaller cross-sections which are necessary in order to move a piston with a specific force, smaller volume flows could be produced, which simplify a drive. For example, a hydraulic pump could pump the required volume flow, for example through a bypass and, if required, into the hydraulic cylinder. This would have a connection to the filling piston to be driven or to the piston device.

However, the hydraulic cylinder could also have a pumping device which provides the high degree of dynamics, or also an axial piston pump, in order thus to provide the required dynamics of the drive.

In this case it would be possible to provide a system with a pumping device and/or pressure generating device for each transforming station, or also an apparatus with one or more pumping devices in parallel, in order to be able to operate several stations from one hydraulic unit.

Overall, the pretensioning offers the advantage that more options in a drive calculation and greater volume flows are possible with the same basic principle (piston or cylinder). The driving device is also more favourable than a larger drive without pretensioning.

It is pointed out that the pretensioning device is also described below as a loading device or as a force loading device which is suitable and intended for loading the element of the pressure generating device in a predetermined direction.

Furthermore, embodiments of the present invention is therefore directed to a method for expanding plastics material parisons into plastics material containers by means of a liquid medium, wherein at least one transforming station fills and expands the plastics material parisons with the liquid medium, and wherein with at least one delivery device the liquid medium is delivered to at least one filling device of the transforming station, wherein the filling device fills the liquid medium into the plastics material parisons, and wherein a pressure generating device delivers the liquid medium under pressure to the transforming station.

According to embodiments of the invention at least one element of the pressure generating device is pretensioned at least at times by means of a pretensioning device. Further advantages and embodiments are disclosed by the appended drawings.

### BRIEF DESCRIPTION

Some of the embodiments will be described in detail, with reference to the following figures, wherein like designations denote like members, wherein:

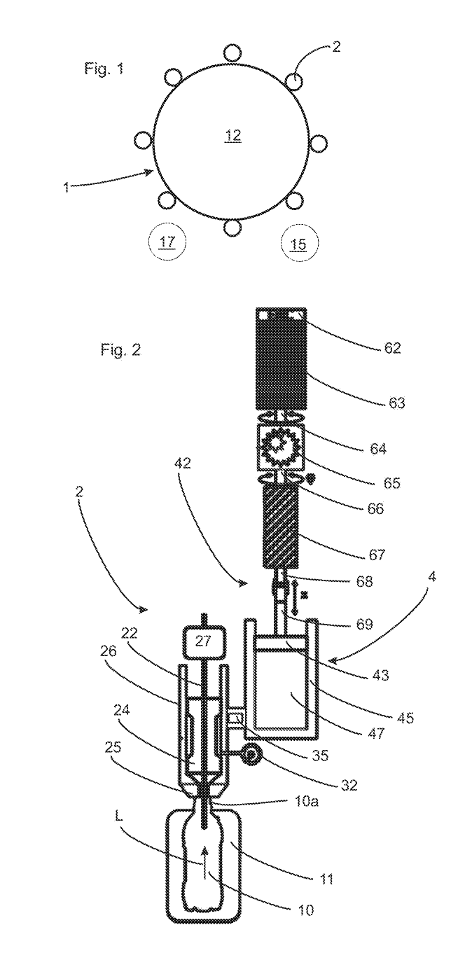

FIG. 1 shows a rough schematic representation of an apparatus;

FIG. 2 shows a representation of a transforming station according to the internal known art of the applicant;

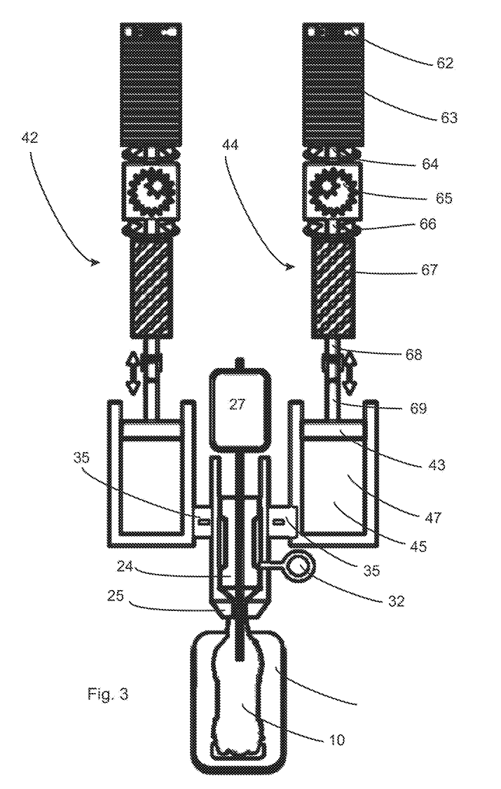

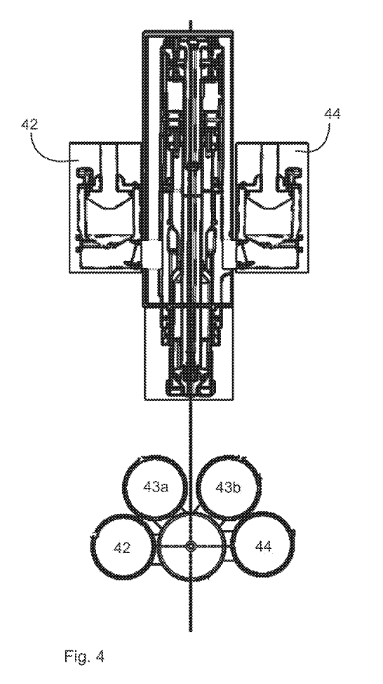

FIG. 3 shows a representation of a transforming station;

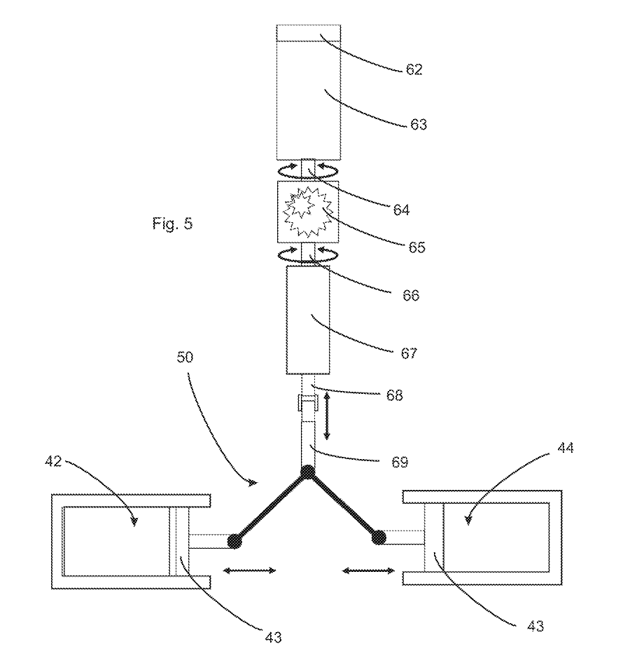

FIG. 4 shows a further representation of a transforming station;

FIG. 5 shows a representation of a pressure generating device with a toggle lever;

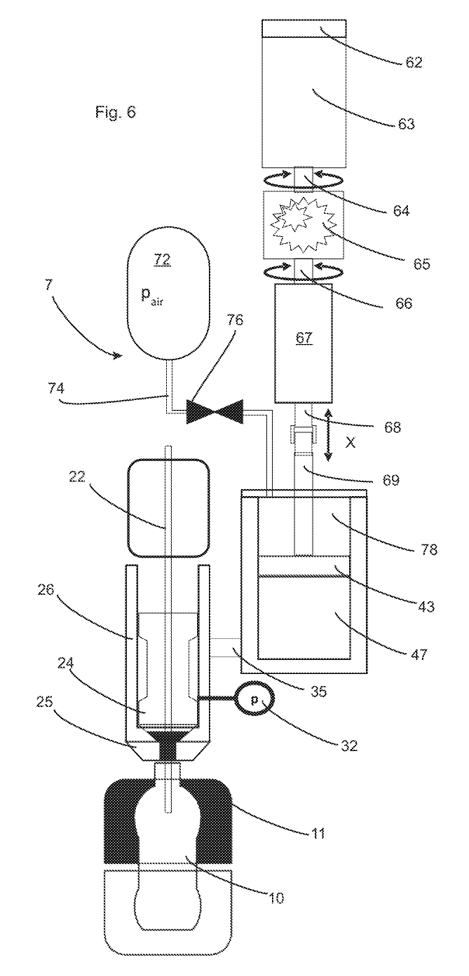

FIG. 6 shows a representation of a transforming station with a pretensioning device; and

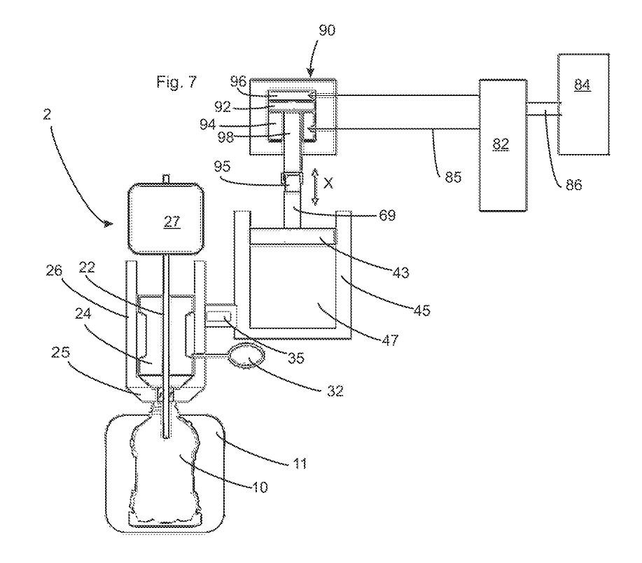

FIG. 7 shows a representation of a transforming device with a hydraulic or pneumatic driving device.

### DETAILED DESCRIPTION

FIG. 1 shows a schematic representation of a machine according to embodiments of the invention for transforming and filling containers. This has a rotatable carrier 12 on which a plurality of transforming/filling devices are arranged. As mentioned above, these transforming devices serve to fill and to expand the plastics material parisons simultaneously with a container. By means of a delivery device 15, such as for instance a delivery star, plastics material parisons are delivered to the apparatus and the finished and filled containers are then transported away from the apparatus by means of a discharge unit 17.

FIG. 2 shows a transforming station 2 according to the internal known art of the applicant. In this case the actual filling device is provided here, which has an application device 25 which can be placed onto a mouth 10a of the plastics material parisons to be expanded, in order thus to fill and to shape the plastics material containers 10. For this purpose, the transforming device has an expansion mould 11, inside which the plastics material parisons are expanded to form the plastics material bottles or plastics material containers. The reference numeral 26 designates a filling housing, inside which a closure device 24, such as for instance a closure stopper, is arranged. The delivery of liquid into the container 10 can be regulated by a movement of this valve body in the longitudinal direction L of the container.

The reference numeral 22 designates a so-called stretching rod which can be introduced into the interior of the containers, in order also to stretch them in their longitudinal direction. For this purpose, the apparatus has a driving device 27 which is suitable and intended for moving the stretching rod in its longitudinal direction.

The reference numeral 4 designates the pressure generating device as a whole which delivers the liquid under pressure to the plastics material container. Here this pressure generating device only has one pressure generating unit. In this case the pressure generating device, more precisely the pressure generating unit, has a receiving chamber 45, inside which the liquid 47 to be filled is provided. In addition, feed conduits can also be provided which deliver the liquid to the receiving chamber 45 (for instance from a reservoir which is not shown).

The reference numeral 43 designates a piston device which is movable in the direction x, in order thus to transport the liquid by means of a connecting conduit 35 to the actual filling head (also designated above as a filling device). The reference numeral 62 designates the driving device in particular in the form of a servomotor 63 which drives the movement of the piston device 43. For this purpose, the driving device generates a rotary movement which is output by means of an output shaft 64. The reference numeral 65 designates a transmission device, such as in this case a planetary gear transmission, and the reference numeral 66 designates a further output shaft. This output shaft in turn drives a linear spindle 67 and this moves rod elements 68 and 69, which are connected by means of a coupling and on which in turn the piston device is arranged.

Therefore, in the embodiment illustrated in FIG. 2 the apparatus merely has one single pressure generating device, which must supply the pressure for filling and expanding the containers. The reference numeral 32 designates a pressure measuring device which measures a pressure occurring in the filling housing 26.

FIG. 3 shows an embodiment of an apparatus or transforming station 2 according to embodiments of the invention. Here the actual filling head is structured in a similar manner to the embodiment shown in FIG. 2, and therefore is not explained in greater detail. Here, however, in contrast to the embodiment shown in FIG. 2, two pressure application units 42 and 44 are provided. These can be constructed in a similar manner and have already been described above, so that the description is not repeated. In this case it is possible that these pressure application units operate concurrently, but they can also fill the containers with a liquid medium in a staggered manner. In addition, it would also be possible that these two pressure application units 42 and 44 receive different liquids in their respective receiving spaces 47 and so for example a mixed product can be delivered to the container 10.

FIG. 4 shows an embodiment in which the total of four pressure application units 42 to 44 are provided, which likewise again are connected by means of connecting conduits to the actual filling device. In this case these four pressure generating units can contain several different products, for example four different products. In this case it would be possible that in turn the driving force is minimised and a product mixture is filled. In this case it is possible that in each of these pressure generating devices a product is provided which, either simultaneously or successively, is pressed by means of the actual filling device into the plastics material parisons to be transformed. In this case the necessary drive power for one of these four pressure generating units could be substantially reduced relative to the power required when only one single pressure generating unit is used.

In addition to or instead of the driving devices described above, however, hydraulic driving devices could also be provided, or also motors with a nut integrated in the rotor and a spindle, which is designed for example as a hollow shaft.

FIG. 5 shows a further embodiment of embodiments of the present invention. In this embodiment likewise two pressure generating units 42 and 44 are provided, wherein, however, the actual filling devices are not illustrated here. In this embodiment only one drive of the type designated above is provided, but in addition there is a lever device 50 which transmits the forces thus generated onto the piston devices 43. This lever device is configured here as a so-called toggle lever which is articulated on both piston devices 43 in order to move them. Thus, in this case the required forces are supplied by a toggle lever. The pressure profile during shaping of the containers necessitates a fast moulding process and, in the case of almost moulded bottles, a short path distance and high retaining forces.

FIG. 6 shows a further embodiment of embodiments of the present invention. In this embodiment the actual filling device has a similar structure to the above-mentioned filling device. The driving device 62-69 also has a similar structure to that mentioned above and therefore is not described further. In addition, however, the machine illustrated in FIG. 6 has a pretensioning device or a pre-loading device 7, which pretensions the piston device 43 downwards in the direction x. In the embodiment shown here this pretensioning device has a reservoir 72 in which for example air can be stored at a specific pressure. This air can be fed into the chamber 78 via a connecting conduit 74 and a valve 76. In this receiving chamber the pressurised air can additionally load the piston device 43 so that it is forced downwards.

Thus, in the embodiment shown in FIG. 6 the contact surface or the contact area for the pretensioning device is the rear side of the piston device 43.

FIG. 7 shows a further embodiment of the apparatus according to embodiments of the invention. In this embodiment the actual filling device is also formed in the manner shown above. Here too there is a receiving chamber 47 and a piston device which is movable relative to this receiving chamber. The embodiment shown in FIG. 7 differs in the type of drive for the piston device. A hydraulic or pneumatic driving device is used here as the driving device. For this purpose, here too a hydraulic chamber 94 is also provided, relative to which a piston element 92 is likewise movable in the direction x. The reference numeral 98 designates a piston rod which in turn is coupled to the piston device 43 by means of a coupling device.

The reference numeral 82 designates a valve which is switchably controlled. A time-controlled volume adjustment could be performed by precise switching of this valve 82. In addition, inside this driving device 90 mechanical stops or a changed volume flow of a pump would also be conceivable. The reference numeral 84 designates a corresponding hydraulic pump which is connected by means of a connecting conduit 86 to the valve 82. In this case the valve can be controlled in such a way that it can convey a hydraulic medium both into the chamber portion 96 and into the chamber portion (or hydraulic chamber) 94. In this case it is also conceivable that the hydraulic drive unit 90 described here would have to be connected only by a rod to the piston device 43 and in this way components which are pollution-intensive have no direct connection. The reference numeral 85 designates a connecting conduit.

The most varied types of pumps from the known art can be considered as a hydraulic pump. In addition, the coupling device 95 can also produce a real separation of the components between the piston rod 98 and the filling piston rod 69.

Therefore, the apparatus generally has a coupling device which couples at least one element of the drive unit to at least the piston device.

Several objects are achieved by the pretensioning described here, which can also be achieved by the embodiment shown in FIG. 7 or by the variant. In this way the driving device is more favourable than a corresponding larger drive without pretensioning. Theoretically a pressure connection can also be dispensed with.

The use of a hydraulic drive unit has the advantages that it usually has smaller dimensions. In addition, faster switching times can also often be implemented, and components which are in part known from the known art or are prefabricated can be used.

Although the present invention has been disclosed in the form of preferred embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements. The mention of a “unit” or a “module” does not preclude the use of more than one unit or module.

### LIST OF REFERENCES

1 apparatus
2 transforming station
4 pressure generating device
6 driving device
7 pretensioning device, loading device
10 plastics material containers
10a mouth
11 expansion mould
12 rotatable carrier
15 delivery device
17 discharge device
22 stretching rod
24 closure device
25 application device
26 filling housing
27 driving device
32 pressure measuring device
35 connecting conduit
42, 44 pressure generating unit
43 piston device
43a,b pressure generating unit
45 receiving chamber
47 liquid to be filled
50 lever device
62 driving device
63 servomotor
64 output shaft
65 transmission device
66 output shaft
67 linear spindle
68 rod element
69 rod element
69 filling piston rod
72 reservoir
74 connecting conduit
76 valve
78 chamber
82 valve
84 hydraulic pump
85 connecting conduit
86 connecting conduit
90 hydraulic drive unit
92 piston element
94 hydraulic chamber, chamber portion
95 coupling device
96 chamber portion
98 piston rod
x direction

1. An apparatus for expanding plastics material parisons into plastics material containers by a liquid medium having at least one transforming station, which fills and expands the plastics material parisons with the liquid medium with at least one delivery device, which delivers the liquid medium to a filling device of this transforming station, wherein this filling device is suitable and intended to fill the liquid medium into the plastics material parisons, and wherein the apparatus has a pressure generating device which delivers the liquid medium under pressure to the filling device, wherein the pressure generating device has a pretensioning device which pretensions at least one element of the pressure generating device.

2. The apparatus according to claim 1, wherein the pressure generating device has a receiving chamber for the liquid medium as well as a piston device which is movable relative to this receiving chamber in order to force the liquid medium to the filling device by a piston movement.

3. The apparatus according to claim 2, wherein the pretensioning device acts indirectly on the piston device and forces this in a predetermined direction.

4. The apparatus according to claim 1, wherein the pretensioning device pretensions the element of the pressure generating device in a translational direction.

5. The apparatus according to claim 1, wherein the pretensioning device has a pretensioning element, which is selected from a group of pretensioning elements which includes mechanical springs, permanent magnet springs, pneumatic springs, hydraulic elements, linear motor-powered elements, combinations thereof.

6. The apparatus according to claim 1, wherein in the interior of a receiving chamber for the liquid medium the pretensioning device generates a pressure which is at least one of greater than 2 bar, greater than 4 bar, greater than 6 bar and/or that in the interior of a receiving chamber for the liquid medium the pretensioning device generates a pressure which is at least one of less than 40 bar, less than 30 bar and less than 20 bar.

7. The apparatus according to claim 1, wherein the pretensioning can be changed and/or switched off.

8. The apparatus according to claim 1, wherein the pressure generating device has a driving device and this driving device has a spindle device.

9. The apparatus according to claim 1, wherein the pressure generating device has a toggle lever.

10. A method for expanding plastics material parisons into plastics material containers by a liquid medium, with at least one transforming station, which fills and expands the plastics material parisons with the liquid medium, wherein with at least one delivery device the liquid medium is delivered to a filling device of the transforming station, wherein the filling device fills the liquid medium into the plastics material parisons, and wherein a pressure generating device delivers the liquid medium under pressure to the filling device, characterised in that at least one element of the pressure generating device is pretensioned at least intermittently by a pretensioning device.
